(19) United States
(12) Patent Application Publication
(10) Pub. No.: US 2025/0093142 A1
(43) Pub. Date: Mar. 20, 2025

(54) SUPPORT DEVICE FOR ADJUSTING AND/OR MEASURING A WHEEL SUSPENSION ARM ASSEMBLY

(71) Applicant: ALFING KESSLER SONDERMASCHINEN GMBH, Aalen (DE)

(72) Inventors: Hinrich STAVE, Nürtingen (DE); Rainer BURKHARDT, Aalen (DE)

(21) Appl. No.: 18/292,084

(22) PCT Filed: Jul. 15, 2022
(86) PCT No.: PCT/EP2022/069836

§ 371 Date: Jan. 25, 2024

(30) Foreign Application Priority Data
Jul. 30, 2021 (DE) 10 2021 119 908.5

(51) Int. Cl. G01B 5/00

(52) U.S. Cl. CPC G01B 5/0004; G01B 5/0025

(57) ABSTRACT

A support device for use in adjusting and/or measuring a wheel suspension arm assembly. By means of the wheel suspension arm assembly, a hub carrier is movably articulated, with a plurality of degrees of freedom of motion, to a beam. The hub carrier is provided and designed for carrying a wheel of a vehicle. The support device includes a holding apparatus for holding the hub carrier, the holding apparatus having a wheel receptacle for receiving the hub carrier. The holding apparatus can be adjusted between a fixing position, in which the hub carrier is stationarily fixed to the holding apparatus, and a releasing position, in which the hub carrier can be removed from the holding apparatus. The holding apparatus is suspended on at least one flexible suspension element; a force application apparatus is provided for applying a wheel load to the hub carrier in a wheel-load direction, and the at least one suspension element supports the holding apparatus with a supporting force in a supporting-force direction opposite the wheel-load direction and movably bears the hub carrier with different degrees of freedom of motion.

The invention relates to a support device for use in adjusting and/or measuring a wheel suspension arm assembly. By means of the wheel suspension arm assembly, a hub carrier is movably articulated, with a plurality of degrees of freedom of motion, to a beam. The hub carrier is provided and designed for carrying a wheel of a vehicle. The support device comprises a retaining apparatus for retaining the hub carrier, the retaining apparatus having a wheel receptacle for receiving the hub carrier. The retaining apparatus can be adjusted between a fixing position, in which the hub carrier is stationarily fixed to the retaining apparatus, and a releasing position, in which the hub carrier can be removed from the retaining apparatus.

Such a support device is described in DE 103 36 619 A1 for example. The retaining apparatus grips the hub carrier for example in the manner of a clamping jaw system, wherein the clamping jaw system is in turn pivotally mounted on pivot bearings, such that the hub carrier is movable for measuring and adjusting check rails, however with respect to a wheel load, which on operation of the vehicle occurs between the carriageway and wheel and acts on the wheel vertical to the carriageway, supported by the retaining apparatus and support device. The mounting is subjected to friction however, such that measurements and adjustments to the check rails are influenced by the mounting.

From DE 601 33 799 T2 a system for analysing a suspension system is known.

US 2010/0126262 A1 describes a support device for a test bench.

DE 195 81 832 T1 concerns a load arrangement for a vehicle shaft test device.

The object of the present invention is thus to provide an improved support device for use in adjusting and/or measuring a suspension arm assembly.

To solve this problem, it is provided in a support device of the type mentioned at the beginning that the retaining apparatus is suspended on at least one flexible suspension body, wherein a force application apparatus is provided for applying a wheel load to the hub carrier in a wheel-load direction, wherein the at least one suspension body supports the retaining apparatus with a supporting force in a supporting-force direction opposite to the wheel-load direction and movably bears the hub carrier with different degrees of freedom of motion.

The wheel load is the force occurring between the carriageway and wheel and acting on the wheel vertical to the carriageway when the vehicle is in operation.

The support device therefore ensures that the retaining apparatus supports the wheel load effectively, otherwise high movability in the hub carrier occurs. For example, the retaining apparatus and therefore the hub carrier, which is possibly retained on the retaining apparatus, is movable in relation to the axes or trajectories which run at an angle or transverse to the wheel-load direction. Furthermore, the retaining apparatus is pivotally or rotatably mounted on the at least one suspension body. For example, the retaining apparatus can rotate around an axis coaxial to the wheel-load direction.

A resulting advantage for example is that no further bearings, in particular bearings with low frictional resistance, are necessary for mounting the retaining apparatus. In fact, the at least one suspension body flexibly yields, in other words, the retaining apparatus suspended on the suspension body is freely movable, apart from deformation force, which is necessary for the suspension body, in particular with respect to the different degrees of freedom of motion according to its deflection.

It is advantageously provided that the at least one flexible suspension body is not spring-loaded and/or has no spring and/or is tension resistant and/or is stretch resistant. It is advantageously provided that the flexible suspension body is designed not in the sense of a spring and/or as a spring. In particular it is advantageous if the suspension body does not comprise a coil spring and/or a cup spring and/or a spiral spring or any formed by these. The stretch resistant and/or tension resistant flexible suspension body can be designed such that it only stretches or distends by a pre-determined extent due to the load from the retaining apparatus.

Preferably in an operating position in which the retaining apparatus is suspended on the at least one flexible suspension body, the at least one flexible suspension body has a constant length or an essentially constant length and/or has an elongate shape.

Preferably, in the operating position, in which the hub carrier is suspended on the at least one flexible suspension body and the at least one suspension body supports the retaining apparatus with the supporting force in the supporting-force direction opposite to the wheel-load direction, the flexible suspension body stretches only by maximum 10%, preferably maximum 8%, in particular maximum 5%, more preferably maximum 3% or even more preferably maximum 2% compared to a load from the suspension body without a hub carrier. It is in particular preferred if the flexible suspension body stretches by maximum 1 per cent, preferably maximum 0.9% or even more preferably by maximum 0.8%, in particular maximum 0.7% or 0.6%. Furthermore, it is advantageous if the flexible suspension body stretches by maximum 0.1%, preferably maximum 0.08%, more preferably maximum 0.07% or maximum 0.06%. The above-mentioned stretching is advantageously brought about by the load from the suspension body due to the hub carrier.

The suspension body has its elongate shape for example on a portion, which extends between the retaining apparatus and the stationary holder. If between the retaining apparatus and the stationary holder a further support contour is arranged, on which the suspension body is supported and it optionally has an angular shape or curvature, the suspension body can have an elongate shape both between the holder and the support contour and between the retaining apparatus and the support contour.

It is advantageously provided that the retaining apparatus is articulated on the at least one suspension body at a point of articulation, which is on a level which extends through a centre of the wheel receptacle and/or which traverses an inner circumference of the wheel receptacle and/or is traversed by a rotary axis, around which a wheel can be mounted or is mounted on the hub carrier.

However it is also advantageous if the at least one suspension body is articulated at a point of articulation on the retaining apparatus, which is on a level approximately equivalent to a carriageway surface, if the suspension arm assembly is arranged on the vehicle.

The point of articulation for the retaining apparatus can also lie on a level, which runs through the centre of the wheel receptacle.

Furthermore, the point of articulation can also lie on a level vertical to the carriageway surface and/or above the point of contact of the wheel on the carriageway surface.

It is possible that only one single suspension body, for example a single rope or a single chain, is provided as a suspension body.

It is also possible that the at least one suspension body comprises at least two or exactly two suspension bodies, for example two ropes or two chains, which are each connected to the retaining apparatus.

It is preferred if the retaining apparatus is suspended on maximum three, in particular maximum two suspension bodies.

Furthermore, it is possible that only a single suspension body is present, which however is connected to the retaining apparatus at two or several points of articulation. For example it is possible that two sides of a single suspension body are each connected to the retaining apparatus at one point of articulation.

The point of articulation is to be understood as the point at which the relevant suspension body introduces force into the retaining apparatus.

For example the point of articulation is the point at which the relevant suspension body projects from the retaining apparatus, in other words, is freely movable relative to the retaining apparatus.

A preferred concept provides for example that the at least one suspension body is articulated at two points of articulation arranged on opposite sides of the centre of the wheel receptacle.

To realise the above-mentioned measure, the following measure can be provided for example. A preferred concept provides, in particular, that the at least one suspension body extends in the nature of a sling around the wheel receptacle and/or points of articulation of the suspension body are arranged on the retaining apparatus and, with respect to an axis in which the supporting force acts on the retaining apparatus, on opposite sides.

The at least one suspension body is preferably arranged on one side on the retaining apparatus and on the other side on a stationary holder. It is however also possible that the suspension body on one side is arranged on the retaining apparatus and on the other side is connected to a holder connected to a positioning actuator. By means of the positioning actuator the holder and the retaining apparatus retained on it using the at least one suspension body can for example be moved with a force component, which is parallel to the supporting force. In this manner, for example to-and-from movements on the retaining apparatus and therefore on the hub carrier can be performed.

It is advantageous if the stationary holder has a separate holder for each side of the at least one suspension body. In this way for example both sides can each be suspended on a holder at a distance from each other. As a result, the movability of the suspension body for example can be improved.

Various designs can be considered as a flexible suspension body, combinations of which are also possible. It can therefore be provided for example that the at least one suspension body comprises a rope and/or a chain and/or a belt, e.g. a textile strap, and/or is formed by these.

In particular it is preferred if the flexible suspension body is a chain or is formed by a chain. Compared to a rope, a chain has for example less tendency to extend under load.

Furthermore, it is advantageous if the flexible suspension body consists of metal, in particular of steel.

For free movability of the retaining apparatus, it helps if the suspension body or the suspension bodies have a relative long length. For example an advantageous measure provides that one length of the at least one suspension body between the retaining apparatus and the stationary holder is at least twice the size, preferably at least three times the size, especially at least four times the size or five times the size as the diameter of the wheel receptacle. It is in particular preferred if the length of the suspension body between the retaining apparatus and the stationary holder is at least nine times or ten times as big as the diameter of the wheel receptacle.

In this way it is possible that the suspension body pivots so to speak around the stationary holder, however, due to its length, pivots in an arc path with such a large radius around the holder that a quasi linear movement along the arc path takes place at least in the area in which the adjustment or measurement of the hub carrier is provided.

The hub carrier is for example to deflect when adjusting and/or measuring by a pre-determined extent, for example in the operating position it is to deflect horizontally.

Accordingly, it is advantageous if, in relation to this deflection, the following definition on the length of the suspension body is observed.

It is advantageously provided that a length of the at least one suspension body between the retaining apparatus and the stationary holder is at least 100 times, preferably at least 250 times or 350 times the path of defection of the hub carrier when adjusting and/or measuring the suspension arm assembly in a direction of motion transverse to the longitudinal extension of the suspension body. The direction of motion or motion axis runs horizontally for example in the operating position.

The retaining apparatus preferably comprises a support base as well as a fixing element movably mounted on the support base between the releasing position and the fixing position. The fixing element is adjustable relative to the support base between the releasing position and the fixing position, for example by means of a pivot bearing and/or a linear bearing. It is advantageous, if the fixing element is adjustably mounted on the support base and movable linearly by means of a linear guide between the releasing position and the fixing position.

It is preferred, if the support base is connected to the at least one suspension body.

The fixing element and the support base contain the wheel receptacle for practical reasons. It is preferred if the fixing element and the support base can each detect a part of the circumference, in particular half the circumference, of the hub carrier.

Centring surfaces can be provided on the wheel receptacle for centring the hub carrier in relation to the wheel receptacle and/or inclined surfaces for guiding the hub carrier into the wheel receptacle.

In principle it is possible that the fixing element is adjusted manually relative to the support base. It is preferred however if the fixing element of the retaining apparatus is adjustable by means of a fixing actuator between the releasing position and the fixing position. The fixing actuator is for example an electric positioning actuator and/or a pneumatic positioning actuator.

The measure explained below can for example help position and/or align the hub carrier optimally in relation to the retaining apparatus.

It is preferably provided that the retaining apparatus has a aligning surface for supporting a front side of the hub carrier, wherein the front side of the hub carrier is traversed by a rotary axis, around which a wheel is mountable or is mounted on the hub carrier, so that the hub carrier is alignable on the aligning surface such that an outer circumference of the hub carrier provided for retaining in the wheel receptacle is untiltable in relation to an inner circumference of the wheel receptacle. The aligning surface can for example be or comprise a plane surface. It is however also possible that the aligning surface is or comprises a inclined surface and/or a centring surface, for example conical surfaces, for the hub carrier. It is preferred if the aligning surface has an adjusted contour on a contour of the hub carrier, provided for abutment to the aligning surface.

A preferred embodiment of the invention provides that the support device has a positioning device for positioning the retaining apparatus on the hub carrier, wherein the positioning device is arranged between a positioning position, in which the retaining apparatus for gripping the hub carrier is positioned on the hub carrier, and a disengaged position, in which the positioning device releases the retaining apparatus for adjusting and/or measuring the suspension arm assembly.

It is preferred if the positioning device is completely removed from the retaining apparatus, when adjustment or measurement of the suspension arm assembly takes place. It is however also possible that a movably mounted coupling element of the positioning device remains in engagement with the retaining apparatus, which in any case does not or only insignificantly effect the movability of the retaining apparatus and therefore any hub carrier it holds.

It is preferred if the positioning device comprises a positioning actuator arrangement for adjusting the retaining apparatus towards the hub carrier and away from the hub carrier. The positioning actuator arrangement comprises for example one or a plurality of positioning actuators, for example the below-explained support element actuator and/or the below-explained retaining apparatus actuator. The at least one positioning actuator is for example an electric actuator, a pneumatic actuator or a combination of both. It is preferred if the at least one positioning actuator is a linear actuator.

For positioning, in particular during the adjustment of the retaining apparatus between the fixing position and the releasing position, a support element is preferably provided. The support element is preferably plate-like. Form-locking elements can be located in front of the support element, which are provided for engaging in form-locking holders on the retaining apparatus. It is however also possible that a form-locking element is located in front of the retaining apparatus for engaging in a form-locking element of the support element.

The support element is preferably a component of the positioning device, in other words it is advantageous if the positioning device comprises a support element for supporting the retaining apparatus.

In principle it is possible to move the retaining apparatus towards the support element and away from the support element, to which the below-explained retaining apparatus actuator is suited.

It can also be envisaged that the retaining apparatus is adjusted manually to the support element or the support element adjusted manually to the retaining apparatus.

It is advantageous if the positioning actuator arrangement has a support element actuator for the support element, wherein by means of the support element actuator, the support element is adjustable towards the retaining apparatus in an engagement position, in which the support element supports the retaining apparatus, and away from the retaining apparatus in the disengagement position, in which the support element is removed from the retaining apparatus. The support element is therefore temporarily positioned on the retaining apparatus or next to the retaining apparatus, for example if the retaining apparatus is adjusted from the fixing position into the releasing position or from the releasing position into the fixing position.

A preferred concept provides that the positioning device has a linear guide for the support element, on which the support element is guided along a linear axis between the engagement position and the disengagement position. It is advantageous if the support element is arranged on a carriage of the linear guide. The carriage can for example be activated by the support element actuator. The support element actuator is preferably an electrical or pneumatic linear actuator.

In principle it is possible that the support element supports the retaining apparatus in a planar manner for example. For example it is possible that the support element positions the retaining apparatus towards or in front of the hub carrier, in particular presses against the hub carrier, for example the said aligning surface of the retaining apparatus adjusts to the hub carrier in the sense of aligning the retaining apparatus on the hub carrier or in the sense of aligning the hub carrier on the retaining apparatus.

A preferred concept provides that form-locking elements are arranged on the support element and the retaining apparatus, which engage with each other in the engagement position and disengage in the disengagement position. For example, the form-locking elements can support the retaining apparatus transverse to a positioning axis, along which the retaining apparatus is adjusted towards the hub carrier and away from the hub carrier. For example the form-locking elements are suitable for supporting a vertical force in the operating position of the support device.

An advantageous concept provides that the form-locking elements comprise at least a mating of a form-locking lug and a form-locking holder with centring contours, wherein the centring contours fix and centre the retaining apparatus in the positioning position on the support element transverse a trajectory, along which the support element is adjustable between the positioning position and the disengaged position. The centring contours are for example conical surfaces, spherical surfaces or equivalent. The centring contours can also comprise other inclined surfaces, which make a centring function possible.

A preferred concept provides that the form-locking elements comprise at least two, preferably at least three matings of form-locking lugs and form-locking holders, wherein the form-locking elements of the retaining apparatus are arranged at an angular distance to each other around the wheel receptacle. Two matings of form-locking lugs and form-locking holders are in particular preferred in order to avoid static redundancy. It is possible that, in addition to the form-locking lugs a support lug is present on the support element or the retaining apparatus, which supports the support element and the retaining apparatus along a support axis, however no force is applied transverse to the support axis. It is then possible that the mutually engaging matings of form-locking lug and form-locking holder enable for example the retaining apparatus to be centred on the support element.

It is also advantageous if the form-locking elements comprise a mating of form-locking lug and the form-locking holder, wherein matching centring contours, in particular inclined surfaces or conical surfaces, are arranged on the form-locking lug and the form-locking holder for centring the form-locking elements to each other as well as, in addition to the centring contours, arranged retaining contours, wherein the retaining contours support the retaining apparatus on the support element transverse to a positioning axis, along which the form-locking elements can be brought into mutual engagement or out of engagement. The retaining contours are for example cylindrical contours. Preferably this mating of form-locking lug and form-locking holder forms the single mating of matching form-locking elements of the support element and the retaining apparatus or the positioning element. Furthermore, it is advantageous if the mating of form-locking lug and form-locking holder according to this design is traversed by an actuator of the retaining apparatus actuator, explained below, or is coaxial to this actuator. In particular it is advantageous if the retaining contours and/or the centring contours are rotationally symmetrical in relation to an axis, which are coaxial to the positioning axis of the retaining apparatus actuator, in particular if the retaining apparatus actuator has brought the retaining contours into mutual engagement.

A preferred concept provides that the positioning actuator arrangement has a retaining apparatus actuator for adjusting the retaining apparatus, wherein the retaining apparatus actuator is motion-coupled to the retaining apparatus and/or can be brought into actuating engagement. It is possible that the retaining apparatus actuator is permanently motion-coupled to the retaining apparatus. Es is however also possible that the retaining apparatus actuator by means of a coupling element, for example a gripper, a hook or equivalent, is only connected to the retaining apparatus if the retaining apparatus actuator adjusts the retaining apparatus towards the hub carrier or away from the hub carrier. Consequently it is also advantageous if the retaining apparatus actuator is out of engagement with the retaining apparatus, if the suspension body supports the retaining apparatus and the retained hub carrier in relation to the wheel-load direction and measurements and adjustments to the suspension arm assembly take place.

It is advantageous if the retaining apparatus actuator is designed for adjusting the retaining apparatus towards the support element and/or away from the support element. For example, the retaining apparatus actuator can activate the retaining apparatus in the direction of the support elements, so that the above-mentioned form-locking elements manage to engage with each other and the retaining apparatus is therefore stationarily retained in relation to the support elements. It is also advantageous, if the retaining apparatus actuator can move the retaining apparatus of the support element far enough way, that the retaining apparatus is movable in relation to the support elements.

It is in particular preferred if the retaining apparatus actuator for adjusting the retaining apparatus away from the support element is designed such that the retaining apparatus is supported on the support element and is still movable relative to the support element. Therefore for example, the above-mentioned form-locking elements can engage, so that the retaining apparatus is supported on the support element. The retaining apparatus is still movable, for example for aligning the hub carrier on the aligning surface of the retaining apparatus in relation to the support element. In this way for example, a position of the retaining apparatus can be adjusted relative to the hub carrier, wherein at the same time the retaining apparatus is supported on the support element.

The support element preferably has an opening for the retaining apparatus actuator. In this way, the retaining apparatus actuator can reach through the support element, so to speak, and be connected to the retaining apparatus. It is preferred if the opening of the support element is approximately in the area of the wheel receptacle of the retaining apparatus, if the retaining apparatus is arranged, in particular centred, on the support element.

It is preferred if the retaining apparatus actuator comprises a linear actuator, wherein a coupling element, which is connected to or couplable to the retaining apparatus, is adjustable along a linear axis by means of the linear actuator. The coupling element comprises for example the pivot bearing explained below.

It is preferred if by means of a retaining apparatus-pivot bearing the retaining apparatus actuator is connected to the retaining apparatus pivotally around at least one retaining apparatus-pivot axis and/or by means of a actuator-pivot bearing is pivotally mounted on a stationary base of the positioning device pivotally around at least one actuator-pivot axis. The pivot bearings can have only one pivot axis each. However it is also possible that at least one of the pivot bearings is a cardan pivot bearing or ball bearing, so that a pivoting is produced with a plurality of degrees of freedom of pivoting motion and/or around a plurality of pivot axes by the respective retaining apparatus-pivot bearing and/or actuator-pivot bearing. Preferably the above-mentioned pivot bearings are in particular smooth-running pivot bearings, so that the retaining apparatus suspended on the at least one suspension body while the adjusting and measuring of the suspension arm assembly is freely movable and the pivot bearings cannot exercise any or hardly any force on the retaining apparatus.

Furthermore, it is advantageous if the retaining apparatus-pivot axis and/or the actuator-pivot axis and/or the linear axis and or a centre of the for example spherical actuator-pivot bearing or a centre of the also spherical retaining apparatus-pivot bearing for example is on a level which extends through a centre of the wheel receptacle and/or an which intercepts an inner circumference of the wheel receptacle and/or is intercepted by a rotary axis, around which a wheel is mountable or is mounted on the hub carrier. In this way, a free movability of the wheel receptacle is produced despite the above-mentioned pivot bearings during the adjusting and/or measuring of the suspension arm assembly.

Exemplary embodiments of the invention are explained below with reference to the drawing, of which:

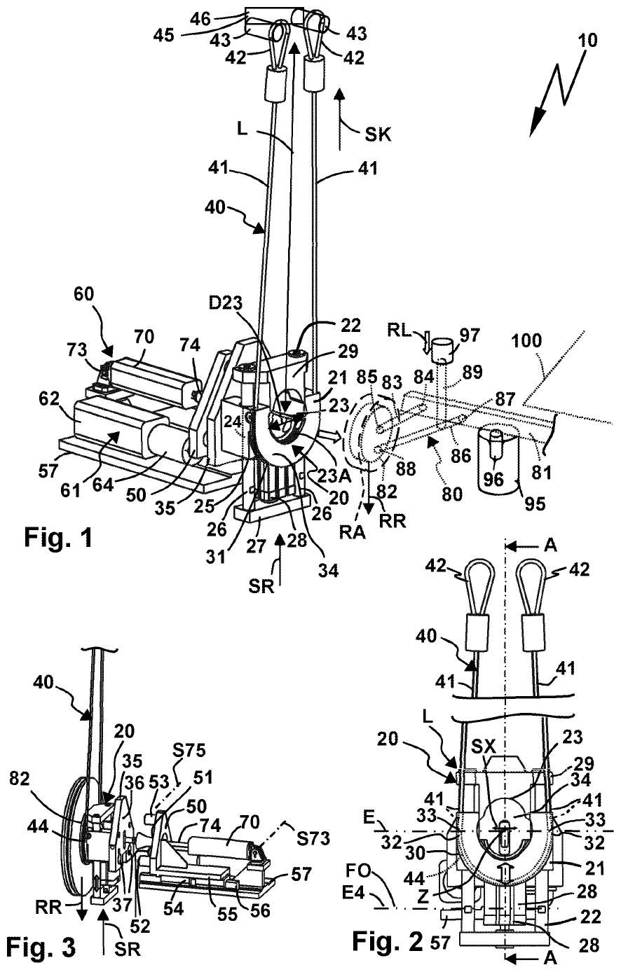

FIG. 1 shows a perspective oblique view of a support device as well as a suspension arm assembly and with a hub carrier and a force application apparatus,

FIG. 2 shows the arrangement according to FIG. 1 from the front,

FIG. 3 shows a view of the support device and of the hub carrier according to the above figures,

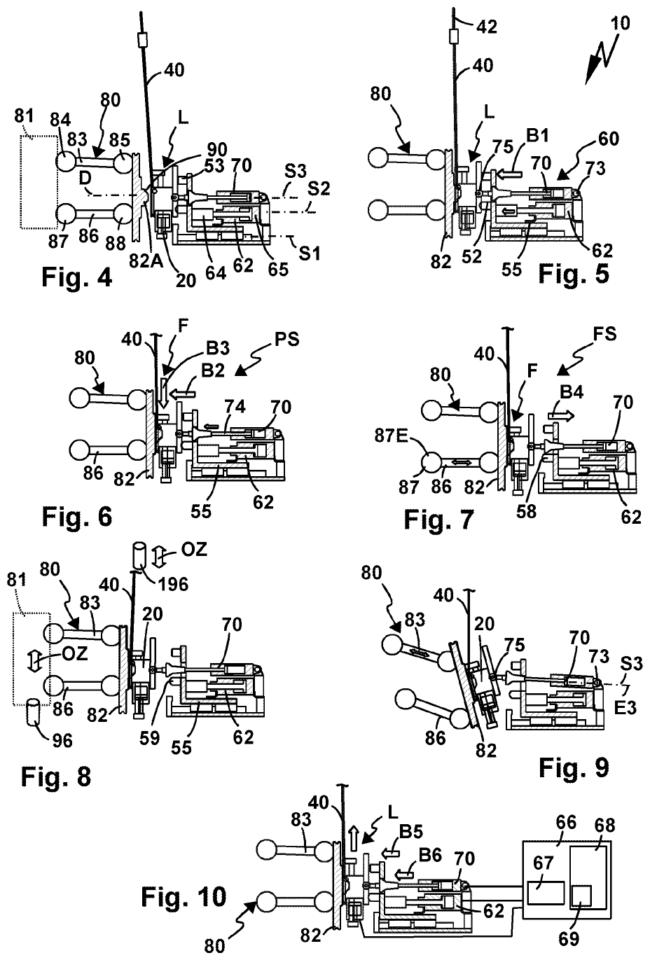

FIG. 4 shows a longitudinal section through the support device according to the above figures approximately along a line A-A in FIG. 2 as well as the suspension arm assembly, wherein the hub carrier is not yet engaged with the support device,

FIG. 5 shows the arrangement according to FIG. 4, wherein a support element actuator of a positioning device adjusts a support element in the direction of an engagement position with a retaining apparatus of the support device,

FIG. 6 shows the arrangement according to FIGS. 4, 5, wherein the retaining apparatus actuator adjusts the retaining apparatus forwards in the direction of the hub carrier and away from and out of engagement with the support element,

FIG. 7 shows the arrangement according to FIGS. 4 to 6, wherein the support element actuator has adjusted the support element out of engagement with the retaining apparatus and the retaining apparatus holds the hub carrier,

FIG. 8 shows the arrangement according to FIGS. 4 to 7, wherein the force application apparatus acts on a check rail with force,

FIG. 9 shows the arrangement according to FIGS. 4 to 8, wherein the hub carrier and the retaining apparatus take on an inclined position,

FIG. 10 shows the arrangement according to FIGS. 4 to 9, wherein the support element for releasing the retaining apparatus engages with the same,

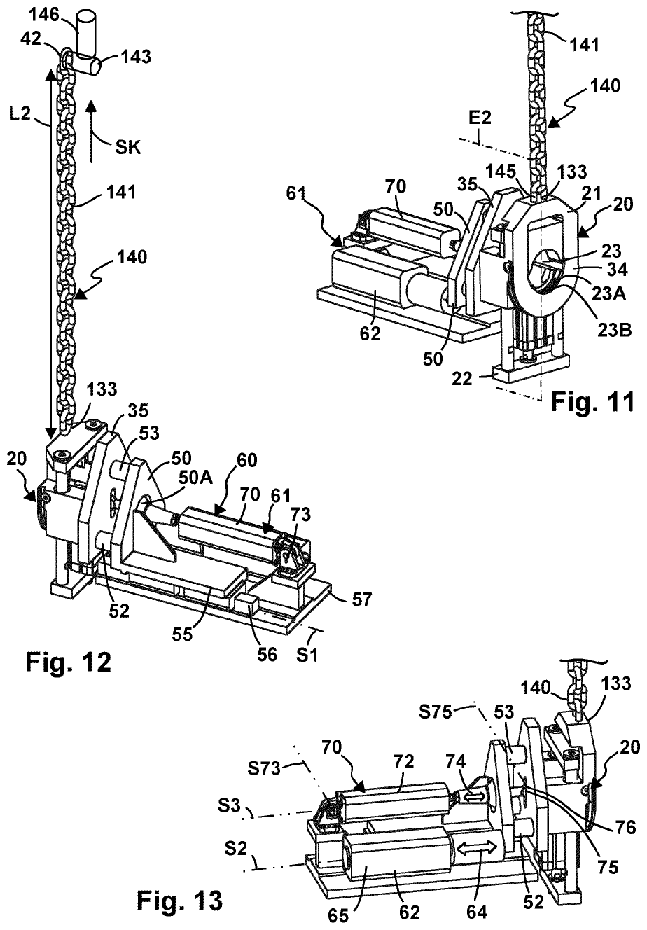

FIG. 11 shows a variant of the support device according to FIG. 1 in a perspective view at an angle from the front,

FIG. 12 shows the support device according to FIG. 11 at an angle from behind,

FIG. 13 shows the support device according to FIGS. 11, 12 at an angle from the side and behind, and

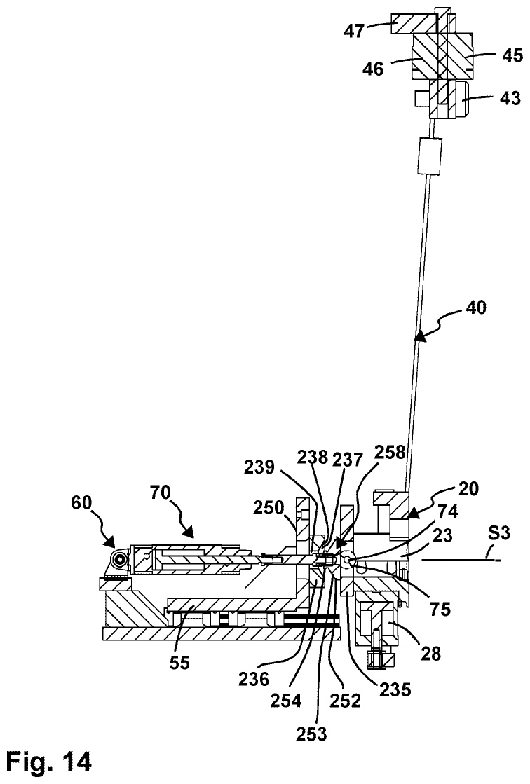

FIG. 14 shows a cross-sectional view of a variant of the support device according to FIGS. 1-10, approximately along the line of intersection A-A in FIG. 2.

A support device 10 is designed for use in adjusting and/or measuring a suspension arm assembly 80, which for example is mounted or can be mounted on a vehicle, which is not shown in the drawing. The suspension arm assembly 80 is used for flexibly connecting and linking a hub carrier 82 to a carrier 81, which is designed in the manner of for example an auxiliary frame, axle component or equivalent and is provided for mounting on a schematically shown vehicle 100.

The hub carrier 82 comprises for example a wheel flange 82A, which is rotatably mounted on the hub carrier 82 around a rotary axis D. The wheel flange 82A can be connected to a brake disc or designed as such. The hub carrier 82 is used for mounting a wheel of the vehicle 100. For example a wheel RA can be arranged on the hub carrier 82, which is rotatably mounted around a rotary axis D, so that the vehicle 100 can run on a surface.

The suspension arm assembly 80 comprises check rails 83, 86, which are linked to a carrier 81 by means of joints 84, 87 as well as to the hub carrier 82 by means of joints 85, 88, for example are pivotally linked.

A body of the vehicle 100 then acts on the suspension arm assembly 80, if said body is connected to the suspension arm assembly 80 or the carrier 81. For example a strut 89 connected to the body of the vehicle 100 acts on the check rail 86.

The carrier 81 is provided to be connected to the body of the vehicle 100 and is for example supported on a supporting apparatus 95 for measuring and/or adjusting the suspension arm assembly 80 as stated above. The supporting apparatus 95 can be stationary or also by means of an actuator in the positioning apparatus 96, which for example comprises one or a plurality of positioning actuators, in particular linear actuators, can be adjustable in relation to its height, for example to provide a force which acts on the carrier 81 from below.

Loading of the strut 89 and therefore of the check rail 86 is for example possible by a force application apparatus 97. The force application apparatus 97 can for example act on the strut 89 and therefore on the check rail 86, so that a wheel load RL acts on the hub carrier 82 in a wheel-load direction RR. With the vehicle 100 in operation, the wheel load RL is equivalent to a force or load occurring between the carriageway and a wheel, which is mountable on the hub carrier 82, and acting on the wheel RA vertical to the carriageway.

A retaining apparatus 20 is used to hold the hub carrier 82. The retaining apparatus 20 comprises a support base 21 as well as a fixing element 22, which contain a wheel receptacle 23 for receiving the hub carrier 82. The fixing element 22 is adjustable relative to the support base 21 between a releasing position L, in which the hub carrier 82 can be guided into the wheel receptacle 23 or guided out the wheel receptacle 23, and a fixing position F, in which the hub carrier 82 is fixed in the wheel receptacle 23.

Preferably the retaining apparatus 20 is designed to hold the wheel flange 82A. The wheel flange 82A is stationarily fixed in the wheel receptacle 23, if the retaining apparatus 20 takes up fixing position F.

As an alternative to the support base 21 and the fixing element 22 for example, a clamping chuck or retaining chuck could also be provided, for example with at least two or three retaining jaws or clamping jaws or equivalent, for retaining the hub carrier 82. Clamping jaws or retaining jaws can also be adjustable between a fixing position F, in which they clamp and hold the carrier 82, and a releasing position L, in which the hub carrier 82 is released from the clamping jaws or retaining jaws.

The retaining apparatus 20 comprises a linear guide 25, with which the fixing element 22 is guided linearly relative to the support base 21. The linear guide 25 comprises for example rod-like guide elements 26, which engage in guide receptacles 24 on the support base 21. The guide receptacles 24 are for example arranged on opposite sides of the wheel receptacle 23 to each other. The guide elements 26 are connected to each other for example on a fixing body 29, which contains a section of the wheel receptacle 23, as well as on a connector 27 opposite the fixing body 29. For example the guide elements 26 are located in front of the fixing body 29 in the style of arms, wherein they traverse the guide receptacles 24 and are connected to their longitudinal end regions opposite the fixing body 29 by the connector 27.

The fixing element 22 is adjustable relative to the support base 21 between the fixing position F and the releasing position L by means of a fixing actuator 28. The fixing actuator 28 is for example a linear actuator, for example a pneumatic or electric linear actuator. The fixing actuator 28 supports itself on one side on the connector 27 and on the other side on the support base 23 on the side of the support base 23 facing away from the fixing body 23.

The retaining apparatus 20 is suspended on a suspension body 40. The suspension body 40 comprises sides 41, which are attached to stationary holders 43 by their longitudinal end regions 42, which for example have slings.

The suspension body 40 is for example a rope. The suspension body 40 is retained on the retaining apparatus 20 on a receptacle 30. The receptacle 30 comprises for example a ring-shaped reception groove 31, which extends around the wheel receptacle 23, in which a loop 44 of the suspension body 40 is captured. End regions 32 of the receptacle 30 form points of articulation 33, at which the rope or suspension body 40 is freely movable relative to the receptacle 30 and therefore relative to the retaining apparatus 20, on the other side however the retaining apparatus 20 is suspended on the rope or suspension body 40 in a manner of speaking.

The points of articulation 33 are located in a level E, which traverses the centre Z of the wheel receptacle 23, if it is in the fixing position F.

Evidently it would however be also possible to provide the points of articulation 33 on a level E4, which is approximately equivalent to a carriageway surface FO, on which the wheel RA stands in real operation. Thus the geometric relationships in the real vehicle 100 can be shown pragmatically when adjusting and/or measuring the suspension arm assembly 80.

Between the points of articulation 33 and the holder 43 the suspension body 40 has a length L, which is larger than the diameter D23 of the wheel receptacle 23, preferably at least 3× or 4× larger than the diameter D23. In this way the retaining apparatus 20 suspended on the holder 43 or the holders 43 can freely oscillate and contribute to movements of the hub carrier 82, wherein the hub carrier 82 is at the same time supported in relation to the wheel load RL by a supporting force in a supporting-force direction SR.

The length L is also preferably at least 100× greater, preferably 250× to 300×, greater than a travel range SX, around which the hub carrier 82 maximally adjusted during its setting procedure.

The supporting-force direction SR and the wheel-load direction RR, in which the wheel load RL acts, are opposite to each other.

A groove 23A, which preferably has a prisma or an inclined surface 23B, is for example provided in the wheel receptacle 23, so that the hub carrier 82 in the wheel receptacle 23 can be caught so to speak. Consequently the groove 23A and its prisma or inclined surface arranged on it, has the effect that the hub carrier 82, if it engages in the wheel receptacle 23 in its releasing position L, can be caught or centred in the wheel receptacle 23 to a certain extent. It is advantageous however if the insertion opening of the wheel receptacle 23 is allocated a aligning surface 34, on which a front side 90 of the wheel flange 82A of the hub carrier 82 can fit for aligning the hub carrier 82 in relation to the retaining apparatus 20.

For positioning the retaining apparatus 20 in relation to the hub carrier 82, the retaining apparatus 20 has a positioning element 35. The positioning element 35 is for example designed like a plate and is arranged on an opposite side of the fixing body 29 to the wheel receptacle 23 or support base 21. The positioning element 35 has for example a supporting surface 36, for example a plane surface, on which form-locking holders 37 are provided.

The form-locking holders 37 are used to interact with a support element 50, which are used to support the positioning element 35. The support element 50 temporarily supports the positioning element 35, if the retaining apparatus 20 is to be brought into or out of engagement with the hub carrier 82.

The support element 50 is designed for example like a plate. On its side 51 facing the positioning element 35 the support element 50 has for example form-locking lugs 52 for working together with the form-locking holders 37 as well as a support lug 53, which is used to support on the plane surface or supporting surface 36 of the positioning element 35.

The form-locking lugs 52 and the form-locking holders 37 form form-locking elements 58. On the form-locking lugs 52 centring contours 59, for example conical contours, are provided, which engage in matching conical contours on the form-locking holders 37. In this way, the form-locking lugs 52 can engage centrally in the form-locking holders 37.

To optionally avoid static redundancy however, a form-locking lug for engaging in a form-locking holder is not provided on the support lug 53.

By means of a linear guide 54, the support element 50 is slidably mounted in relation to a linear axis S1. The linear guide 54 comprises for example a carriage 55, which in relation to the linear axis S1 is slidably mounted on a guide body 56, for example at least one rail, which is arranged on a guide base 57. The support element 50 is located for example like a shield in front of the carriage 55.

The support element 50 and the linear guide 54 for components of a positioning device 60 for positioning the retaining apparatus 20 in relation to the hub carrier 82.

The positioning device 60 comprises a positioning actuator arrangement 61 with a support element actuator 62 for driving the support element 50. The support element actuator 62 comprises for example a linear actuator 63, which on one side is attached to the guide base 57 and on the other side is connected to the carriage 55. An actuator 64 of the support element actuator 62 is connected for example to the carriage 55 and in relation to an actuator base 65 of the support element actuator 62 can be activated along a linear axis S1, for example electrically and/or pneumatically. The support element actuator 62 therefore is used to adjust the support element 50 towards or away from the retaining apparatus 20 along the linear axis S1.

The retaining apparatus 20 can be driven by means of a retaining apparatus actuator 70. The retaining apparatus actuator 70 comprises for example a linear actuator 71. An actuator base 72 of the linear actuator 71 is preferably supported on the guide base 57 by means of a pivot bearing 73. The pivot bearing 73 is preferably a ball bearing, a cardan bearing, a spherical bearing or equivalent.

An actuator 74 of the retaining apparatus actuator 70 forms a control unit and has a coupling element 76 on its longitudinal end region that is disconnected from the actuator base 72, and which can be activated on the actuator base 72 along a positioning axis S3, for example electrically and/or pneumatically. The actuator 74 and/or the coupling element 76 traverse an opening 50A of the support element 50. By means of a pivot bearing 75 the coupling element 76 and therefore the retaining apparatus actuator 70 are motion-coupled to the retaining apparatus 20. The pivot bearing 75 is preferably a ball bearing, cardan bearing, spherical bearing or equivalent.

Therefore the retaining apparatus actuator 70 can pivot around at least one pivot axis S73 of the pivot bearing 73 in relation to the guide base 57 and around at least one pivot axis S75 of the pivot bearing 75. Preferably the pivot bearings 73 and 75 are cardan bearings or ball bearings, so that the pivot axes S73 and S75 are just one of a plurality of pivot axes of the pivot bearings 73 and 75.

The pivot axes S73 and S75 run parallel to each other. The pivot axes S73 and S75 run transverse, preferably transverse at right angles, to the positioning axis S3. The pivot axes S73 and S75 as well as the positioning axis S3 are arranged preferably on a common level E3.

The retaining apparatus actuator 70 can adjust the retaining apparatus 20 in relation to the support element 50, for example away from or towards the retaining apparatus 20. In this way it is also possible for the retaining apparatus actuator 70 to move the positioning element 35 towards the support element 50, in particular into abutment with the support element 50, and away from the support element 50, for example out of engagement with the support element 50 or in movable engagement with the support element 50.

Preferably the retaining apparatus actuator 70 holds the positioning element 35 in engagement with the support element 50 at all times, wherein this engagement is a fixed engagement, where the positioning element 35 is immovable and/or is retained securely in relation to the support elements 50, or where it can be a movable engagement, so that the positioning element 35 is supported on the support element 50, however is movable for positioning on the hub carrier 82 for example. In this way therefore, if the retaining apparatus 20 is removed from the hub carrier 82, it is also possible to guide the positioning element 35 over the support element 50.

The support device 10 has a control 66 with a processor 67, which is designed to execute programming code of a control program 69. The control program 69 is for example stored in a memory 68 in the control 66. The memory 68 comprises for example a flash memory or equivalent. Further components of the control 66, for example an input interface and/or an output interface for connecting the positioning actuator arrangement 61, in particular the support element actuator 62 as well as the retaining apparatus actuator 70 are not shown in the drawing for reasons of simplification.

Furthermore, the control 66 is preferably designed for controlling the positioning actuator 96 as well as a positioning actuator 196. Finally, it is also possible that the force application apparatus 97 has a positioning actuator for adjusting the wheel load RL, wherein this positioning actuator can preferably be controlled by the control 66.

Furthermore, the control 66 can comprise sensors, which are not shown, for determining the respective position of components of the positioning device 60, for example the carriage 55 and thus the support elements 50, a position of the retaining apparatus actuator 70 or interaction of this sort or sensors of this type.

Furthermore, it is advantageous to measure an acting force provided on the suspension body 40 and/or the supporting force SK provided through the suspension body 40, for which a force measuring device 45 for example is provided. The force measuring device 46 comprises for example a load cell 45, on which the holder 43 is arranged. The load cell 45 or force measuring device 46 is for example fastened in a fixed attachment point 47, for example a retaining bracket or equivalent.

By means of the force measuring device 45 and/or the above-mentioned sensors can for example also be provided force control loops or equivalent for adjusting the supporting force SK at the control 66.

Furthermore, it is also possible to arrange a force measuring device on a relevant side of a suspension body or at a point of articulation of the suspension body on the retaining apparatus. In this way, force sensors, for example load cells, strain gauges or equivalent, and other sensors can be provided in the sides 41 or on the sides 41 and/or at the point of articulation 33.

The process of a typical positioning of the retaining apparatus 20 on the hub carrier 82, then the measuring operation or adjusting operation and then the removal of the retaining apparatus 20 from the hub carrier 82 is schematically shown in FIGS. 4 to 10.

The steps and functions explained below can be controlled by the control 66 by means of the control program 69.

In FIG. 4 the retaining apparatus 20 is removed by the hub carrier 82. The retaining apparatus 20 is in its releasing position L.

FIG. 5 shows that the support element actuator 62 first runs the support element 50 onto the positioning element 35 in a movement B1. Thus the aligning surface 34 and the front side 90 of the hub carriers 82 initially have no contact. The retaining apparatus actuator 70 can still be motionless. It is however also possible that the retaining apparatus actuator 70 is already partially pre-adjusted to the hub carrier 82. It is preferred if, in the position shown in FIG. 5, the form-locking elements 58 are mutually engaged, so that the positioning element 35 is supported on the support element 50.

FIG. 6 shows how the retaining apparatus actuator 70 adjusts the positioning element 35 abutting the hub carrier 82 within a movement B2, so that a positioning position PS is set. It is recognised that there exists some play between the form-locking elements 58, wherein however the form-locking elements 58 are still basically mutually engaged. Consequently the form-locking elements 58 are still lifted to a certain extent away from each other, but still grip each other so that the positioning element 35 is supported on the support element 50. It is advantageous if in the position according to FIG. 6 only a mating of form-locking elements 58 engages, so the retaining apparatus 20 has a large freedom of movement in relation to the support element 50.

The matings of form-locking elements 58 can be engaged one after the other if the positioning element 35 or the retaining apparatus 20 is adjusted in the direction of the support elements 50 and likewise disengaged one after the other, if the positioning element 35 or the retaining apparatus 20 is adjusted away from the support element 50. In the latter case the positioning element 35 or the retaining apparatus 20 becomes increasingly free of the support element 50, so that the retaining apparatus 20 positionable in relation to the hub carrier 82, in other words it is adjustable in the relevant position of the hub carrier 82 without being obstructed by the support element 50.

Through the play of the positioning element 35 and the movability in relation to the support element 50 it is possible for the retaining apparatus actuator 70 to bring the aligning surface 34 into abutment with the front side 90 of the hub carrier 82 with the movement B2. In this way the hub carrier 82 and the aligning surface 34 and finally the retaining apparatus 20 are aligned to each other, so that the fixing actuator 28 can adjust the retaining apparatus 20 from releasing position L to fixing position F in a movement B3. As a result an outer circumference of the hub carrier 82, which extends around the front side 90, is fixed in the wheel receptacle 23. This outer circumference of the hub carrier 82 can be for example an outer circumference of a wheel rim centring collar.

FIG. 7 shows how in a movement B4 of the support element actuator 82 the carriage 55 and thus the support element 50 is adjusted away from the retaining apparatus 20, so that the retaining apparatus 20 becomes free and suspends solely on the suspension body 40. This corresponds to a disengaged position FS. In this disengaged position FS the retaining apparatus 20 and the retained hub carrier 82 are essentially freely movable apart from the vertical support by the suspension body 40 in the exemplary embodiment.

The retaining apparatus 20 is only supported by the suspension body 40 in relation to a linear vertical degree of freedom of motion, in other words by a total of 6 degrees of freedom of motion, namely 3 linear degrees of freedom of motion and 3 pivot degrees of freedom of motion, and the retaining apparatus 20 and the retained hub carrier 82 are freely movable in 5 degrees of freedom of motion and only supported with regard to a linear degree of freedom of motion, which is vertical in the exemplary embodiment.

In principle the hub carrier 82 can rotate around the rotary axis D in relation to the wheel flange 82A, so that an additional rotary degree of freedom of the hub carrier 82 results.

For example the retaining apparatus actuator 70 is an electric and/or pneumatic actuator, which is unpowered and pressureless in the disengaged position FS. In this way a piston of the retaining apparatus actuator 70 can freely move and not or only insignificantly counteract movements of the retaining apparatus 20 and the retained hub carrier 82.

In principle measurement and/or adjustment of the suspension arm assembly 80 can now take place directly, for example of the check rail 83 and/or of the check rail 86 as well as additional check rails not shown in the drawing. For example the joint 87 comprises an adjustment apparatus 87E to adjust a length of the check rail 86, which is indicated by a double arrow in the check rail 86. The adjustment apparatus 87E comprises for example a cam or equivalent. The hub carrier 82 freely suspended so to speak on the suspension body 40 is in relation to the wheel load RL supported by the suspension body 40, but can otherwise continue to move freely.

The joints 84, 85 as well as 87, 88 can however have flexible components, for example rubber elements or equivalent, which are retracted so to speak in a pulsed operation or oscillation operation, shown in FIG. 8. In this way for example the flexible components can be relaxed or adjusted to everyday operation of the suspension arm assembly 80, so that the subsequent measuring and/or adjusting of the suspension arm assembly 80 can optimally take place. For example, the control 66 controls the positioning actuator 96 to generate the oscillation movement OZ.

In principle it can be envisaged for example that the force application apparatus 97 has a kind of positioning actuator, so that this can generate the oscillation movement OZ for example over the strut 89.

Finally it is also possible that the suspension body 40 implements the oscillation movement OZ. For example an actuator 196 is arranged on the holder 43, with which the holder 43 can be activated in the oscillation movement OZ, hence an oscillating stroke movement. At this point it should be mentioned however that other oscillation movements OZ than linear movements are of course possible, for example pivot movements or superimposed pivot-stroke movements. A single movement is readily sufficient to retract the flexible components of the suspension arm assembly. Consequently an oscillating movement or oscillation movement OZ is therefore not absolutely necessary.

FIG. 9 aims to clarify that by means of the flexible suspension of the retaining apparatus 20 and therefore of the retained hub carrier 82 extreme deflections of the suspension arm assembly 80 are possible, therefore also pivot movements for example around the points of articulation 33. Of course the suspension body 40 can also movably oscillate on the holder 43 or completely deform, as the suspension body 40 is flexible. By means of the favourable arrangement of the pivot axes S73, S75 and the slight movability of the pivot bearings 73, 75 the positioning device 60 has only a small retroactive effect on the retaining apparatus 20, if the positioning device 60 takes on the disengaged position FS.

In principle it would be possible however for the coupling element 76 in the disengaged position FS to be removed from the retaining apparatus 20, for example if the coupling element 76 is designed as a hook or other equivalent gripping body. For example a pivot operation could exist, with which the retaining apparatus actuator 70 could be swiveled in order to bring the coupling element 76 into or out of engagement with hook receptacle of the retaining apparatus 20, which is not shown in the drawing. The exemplary embodiment according to FIGS. 11 to 13 is essentially the same as the already explained exemplary embodiment. In any case in the exemplary embodiment, the retaining apparatus 20 is suspended according to FIGS. 11 to 13 on a suspension body 140, which comprises for example a chain 141, wherein however a rope, belt or equivalent would also be possible. The suspension body 140 comprises only a single side or a single strand.

The one longitudinal end 42 of the suspension body 141 is suspended on a holder 143 equivalent to holder 43. The suspension body 141 extends over a length L2 up to a point of articulation 133 on the retaining apparatus 20, where it is connected to the retaining apparatus 20 with a longitudinal end opposite to the longitudinal end 42. For example there exists an eyelet 145 at the point of articulation 133 for the chain 141 or the suspension body 140. The holder 143 can for example for example a force measuring device 146 for detecting and measuring the supporting force SK, with which the suspension body 141 supports the retaining apparatus 20.

The length L2 is also essentially larger than the diameter D23 of the wheel receptacle 23, so that a pivot movement of the retaining apparatus 20 around the holder 143 is an essentially linear movement in the area of the wheel receptacle 23. The length L2 is measured in relation to a maximum horizontal displacement of the hub carrier 82, which can result by means of a camber and track setting, wherein the length L2 is for example is 250× to 300× of an equivalent travel range, for example of the already explained travel range SX.

The eyelet 145 or point of articulation 133 is located on an upper side 121 of the support base 21 on a level E2, in which the centre Z of the wheel receptacle 23 is also located. In this way therefore, the rotary axis D of the hub carrier 82 is also on level E2, if the hub carrier 82 is retained in the wheel receptacle 23.

In the variant according to FIG. 14 a support element 250 is provided on the carriage 55 instead of the support element 50, which is used to support and position a positioning element 235, which is provided instead of the positioning element 35.

Instead of a plurality of form-locking elements 58 a single form-locking lug 252 is provided on the positioning element 35, which can engage in a form-locking holder 237 of the support element 250. The closure lug 252 and the form-locking holders 237 form form-locking elements 258.

For example a receiving body 236 is provided on the support element 250, on which the form-locking holder 237 is provided.

The form-locking holder 237 can be provided on a clamping device or collet. The form-locking holder 237 can however also be designed as a stationary contour in relation to the support element 250.

For example the form-locking lug 252 has centring contours 253, for example inclined surfaces or a cone. The form-locking holder 237 also has matching mating contours, for example a tapered centring contour 238.

Furthermore, the form-locking lug 252 has for example a cylindrical retaining contour 254 on its free end region, which is provided for engaging in a preferably likewise cylindrical retaining contour 239 of the form-locking holder 237. The retaining contours 254 and 237 are for example rotationally symmetrical in relation to the positioning axis S3. If the retaining contour 254 is engaged with the retaining contour 239, the positioning element 235 is stationarily retained in relation to the support element 250 in all axis directions transverse to the positioning axis S3. In the area of the cylindrical retaining receptacle 239, movable retaining components, for example clamping jaws, retaining jaws or equivalent can be provided. In this way the positioning element 235 can be fully stationarily fixable on the support element 52.

If the form-locking lug 252 is moved out of the form-locking holder 237, as shown in FIG. 14, the retaining apparatus 20 becomes free of the positioning device 60 to the extent that the retaining apparatus actuator 70 can adjust the retaining apparatus 20 along the positioning axis S3, wherein the retaining apparatus 20 is movable in relation to the hub carrier 82 by means of the pivot bearing 75 and therefore positionable.

1. A support device for use in adjusting and/or measuring a wheel suspension arm assembly, wherein by means of the wheel suspension arm assembly, a hub carrier is movably articulated, with a plurality of degrees of freedom of motion, to a beam, wherein the hub carrier is provided and designed for carrying a wheel of a vehicle, wherein the support device comprises a retaining apparatus for retaining the hub carrier, the retaining apparatus having a wheel receptacle for receiving the hub carrier, wherein the retaining apparatus can be adjusted between a fixing position, in which the hub carrier is stationarily fixed to the retaining apparatus, and a releasing position, in which the hub carrier can be removed from the retaining apparatus, and wherein the retaining apparatus is suspended on at least one flexible suspension element, wherein a force application apparatus is provided for applying a wheel load to the hub carrier in a wheel-load direction, and the at least one suspension element supports the retaining apparatus with a supporting force in a supporting-force direction opposite the wheel-load direction and movably bears the hub carrier with different degrees of freedom of motion, and wherein the at lease one flexible suspension body is not spring-loaded and/or has no spring and/or is tension resistant and/or is stretch resistant.

2. The support device according to claim 1, wherein the retaining apparatus is articulated at the at least one suspension body at a point of articulation, which is located on a level that extends through a centre of the wheel receptacle and/or which intercepts an inner circumference of the wheel receptacle and/or is intercepted by a rotary axis, around which a wheel is mountable or is mounted on the hub carrier and/or is located on a level, which is located on a level approximately equivalent to a carriageway surface, if the suspension arm assembly is arranged on the vehicle.

3. The support device according to claim 1, wherein the at least one suspension body is articulated on two points of articulation arranged on opposite sides of the centre of the wheel receptacle.

4. The support device according to claim 1, wherein the at least one suspension body extends in the nature of a sling around the wheel receptacle and/or points of articulation of the suspension body are arranged on the retaining apparatus and, with respect to an axis in which the supporting force acts on the retaining apparatus, on opposite sides.

5. The support device according to claim 1, wherein the at least one suspension body, on the one hand, is arranged on the retaining apparatus and, on the other hand, on a stationary holder.

6. The support device according to claim 5, wherein the stationary holder for each side of the at least one suspension body has a separate holder.

7. The support device according to claim 1, wherein the at least one suspension body comprises a rope and/or a chain and/or a belt.

8. The support device according to claim 1, wherein one length of the at least one suspension body between the retaining apparatus and the stationary holder is at least twice the size as the diameter of the wheel receptacle.

9. The support device according to claim 1, wherein a length of the at least one suspension body between the retaining apparatus and the stationary holder is at least 100× the path of defection of the hub carrier when adjusting and/or measuring the suspension arm assembly in a direction of motion transverse to the longitudinal extension of the suspension body.

10. The support device according to claim 1, wherein the retaining apparatus has a support base, which is connected to the at least one suspension body, as well as a fixing element movably mounted on the support base between the releasing position and the fixing position.

11. The support device according to claim 1, wherein by means of a fixing actuator the fixing element of the retaining apparatus is adjustable between the releasing position and the fixing position and/or by means of a linear guide the fixing element, which is adjustably mounted on the support base, is movable linearly between the releasing position and the fixing position and/or the retaining apparatus comprises a clamping chuck or retaining chuck, wherein the fixing element comprises at least a clamping jaw or retaining jaw, which is movably mounted on the support base between the fixing position and the releasing position.

12. The support device according to claim 1, wherein the retaining apparatus has an aligning surface for supporting a front side of the hub carrier, wherein the front side of the hub carrier is traversed by a rotary axis, around which a wheel is mountable or is mounted on the hub carrier, so that the hub carrier is alignable on the aligning surface such that an outer circumference of the hub carrier provided for retaining in the wheel receptacle is untiltable in relation to an inner circumference of the wheel receptacle.

13. The support device according to claim 1, further comprising a positioning device for positioning the retaining apparatus on the hub carrier, wherein the positioning device is arranged between a positioning position, in which the retaining apparatus for gripping the hub carrier is positioned on the hub carrier, and a disengaged position, in which the positioning device releases the retaining apparatus for adjusting and/or measuring the suspension arm assembly.

14. The support device according to claim 1, further comprising a support element for supporting the retaining apparatus.

15. The support device according to claim 1, wherein the positioning device comprises a positioning actuator arrangement for adjusting the retaining apparatus towards the hub carrier and away from the hub carrier.

16. The support device according to claim 15, wherein the positioning actuator arrangement has a support element actuator for the support element, wherein by means of the support element actuator, the support element is adjustable towards the retaining apparatus in an engagement position, in which the support element supports the retaining apparatus, and away from the retaining apparatus in the disengagement position, in which the support element is removed from the retaining apparatus.

17. The support device according to claim 15, wherein the positioning device has a linear guide for the support element, on which the support element is guided along a linear axis between the engagement position and the disengagement position.

18. The support device according to claim 15, wherein form-locking elements are arranged on the support element and the retaining apparatus, which engage with each other in the engagement position and disengage in the disengagement position.

19. The support device according to claim 18, wherein the form-locking elements comprise at least a mating of a form-locking lug and a form-locking holder with centring contours, wherein the centring contours fix and centre the retaining apparatus in the positioning position on the support element transverse to a trajectory, along which the support element is adjustable between the positioning position and the disengaged position.

20-34. (canceled)

35. The support device according to claim 1, wherein, in an operating position in which the retaining apparatus is suspended on the at least one flexible suspension body, the at least one flexible suspension body has an essentially constant length and/or has an elongate shape.
